(19) United States
(12) Patent Application Publication
(10) Pub. No.: US 2011/0080273 A1
(43) Pub. Date: Apr. 7, 2011

(54) Sensation Presenting System and Sensation Presenting Device

(75) Inventors: Takashi Kawai, Honjo-shi (JP); Hiroyuki Morikawa, Honjo-shi (JP)

(73) Assignee: Waseda University, Tokyo (JP)

(21) Appl. No.: 12/997,525

(22) PCT Filed: Jun. 12, 2009
(86) PCT No.: PCT/JP2009/060773

§ 371 Date: Dec. 10, 2010

(30) Foreign Application Priority Data
Jun. 13, 2008 (JP) 2008-155508

(51) Int. Cl. H04B 3/36

(52) U.S. Cl. 340/407.1

(57) ABSTRACT

There are provided a sensation presenting system and a sensation presenting device which allow a user to perceive a desired tactual stimulation based on a virtual bodily pseudo image recognized through a visual sensation. When a tactual sensing unit 5 gives a tactual stimulation to a back hand 3 of a user 2, and when a motional video picture is presented which displays a bodily pseudo image 25 and a tactual-sensing-unit pseudo image 26 are both in a virtual space, and in which the tactual-sensing-unit pseudo image 26 gives a virtual tactual stimulation to the bodily pseudo image 25, a motional video picture different from an operation of giving the tactual stimulation to the back hand 3 by the tactual sensing unit 5 is presented, and the user 2 is allowed to perceive a tactual stimulation corresponding to the virtual tactual stimulation based on the visual stimulation by the motional video picture and the tactual stimulation given by the tactual sensing unit 5, thereby allowing the user 2 to perceive a desired tactual stimulation.

### TECHNICAL FIELD

The present invention relates to a sensation presenting system and a sensation presenting device.

### BACKGROUND ART

Recently, various systems relating to an input device with a tactual feedback, such as a data glove, are developed and become commercially available. For example, PHANToM (a product name) made by SensAble Technologies Inc., U.S.A. enables various expression of the texture of a virtual object through a stick type interface. Such devices are, however, focused on precisely producing reactive force and a skin feeling in the real world, and need a complex driving system in order to produce the skin feeling, etc., so that the configuration becomes complex, resulting in the high production costs.

In view of such a problem, the inventors of the present invention are devoting their efforts to, for example, an invention relating to a sensation presenting device in consideration of human bodily feelings in a virtual space, an invention relating to a simulation device intended for improving the feeling balance of a worker through a manipulation of bodily feelings (see, for example, patent literatures 1 and 2).
Patent Literature 1: JP2003-330582A
Patent Literature 2: JP2007-304973A

### DISCLOSURE OF INVENTION

### Problem To Be Solved By the Invention

In various fields including an entertainment and a production, etc., it is desirable to create a more advanced virtual/real world, so how to allow a user to sense a desired tactual stimulation based on a virtual bodily pseudo image recognized through the user's visual sense is being studied.

The present invention has been made in view of the foregoing circumstances, and it is an object of the present invention to provide a sensation presenting system and a sensation presenting device which can allow a user to sense a desired tactual stimulation based on a virtual bodily pseudo image recognized through the user's visual sense.

### Means For Solving the Problem

A sensation presenting system according to a first aspect of the present invention comprises: tactual sensation presenting means that gives a tactual stimulation to a predetermined body part of a user by a tactual sensing unit; and a visual sensation presenting means which displays a bodily pseudo image corresponding to the predetermined body part and a tactual-sensing-unit pseudo image corresponding to the tactual sensing unit in a virtual space, and which presents the user a motional video picture in which the tactual-sensing-unit pseudo image gives a virtual tactual stimulation to the bodily pseudo image, thereby giving a visual stimulation to the user, wherein the visual sensation presenting means presents a motional video picture different from an operation of giving the tactual stimulation to the predetermined body part by the tactual sensing unit, and allows the user to perceive a tactual stimulation corresponding to the virtual tactual stimulation based on the visual stimulation given by the motional video picture and the tactual stimulation given by the tactual sensing unit.

According to a second aspect of the present invention, the tactual sensation presenting means gives the tactual stimulation by moving the tactual sensing unit with the tactual sensing unit contacting the predetermined body part, and the visual sensation presenting means presents, with the tactual-sensing-unit pseudo image being superimposed on the bodily pseudo image in the virtual space, a motional video picture in which the tactual-sensing-unit pseudo image moves by a travel distance different from an actual travel distance of the tactual sensing unit, thereby giving a visual stimulation to the user.

According to a third aspect of the present invention, the tactual sensation presenting means gives the tactual stimulation by causing the tactual sensing unit to contact/non-contact the predetermined body part, and the visual sensation presenting means presents a motional video picture in which the tactual-sensing-unit pseudo image is superimposed on the bodily pseudo image in the virtual space when the tactual sensing unit is in a non-contact state with the predetermined body part, and the tactual-sensing-unit pseudo image is moved apart from the bodily pseudo image when the tactual sensing unit is in a contact state with the predetermined body part, thereby giving the visual stimulation.

According to a fourth aspect of the present invention, the tactual sensation presenting means halts the tactual sensing unit with the tactual sensing unit contacting the predetermined body part in order to keep giving the tactual stimulation, and the visual sensation presenting means presents a motional video picture in which the tactual-sensing-unit pseudo image displayed in the virtual space moves in a predetermined direction, thereby giving the visual stimulation.

According to a fifth aspect of the present invention, the tactual sensation presenting means moves the tactual sensing unit with the tactual sensing unit contacting the predetermined body part in order to give the tactual stimulation, and the visual sensation presenting means presents a motional video picture in which the bodily pseudo image moves in the predetermined direction with the tactual-sensing-unit pseudo image displayed in the virtual space standing still, thereby giving the visual stimulation.

A sensation presenting device according to a sixth aspect of the present invention comprises: control means that controls: tactual sensation presenting means that gives a tactual stimulation to a predetermined body part of a user by a tactual sensing unit; and a visual sensation presenting means which displays a bodily pseudo image corresponding to the predetermined body part and a tactual-sensing-unit pseudo image corresponding to the tactual sensing unit in a virtual space, and which presents the user a motional video picture in which the tactual-sensing-unit pseudo image gives a virtual tactual stimulation to the bodily pseudo image, thereby giving a visual stimulation to the user, wherein the control means causes the visual sensation presenting means to present a motional video picture different from an operation of giving the tactual stimulation to the predetermined body part by the tactual sensing unit, and allows the user to perceive a tactual stimulation corresponding to the virtual tactual stimulation based on the visual stimulation given by the motional video picture and the tactual stimulation given by the tactual sensing unit.

According to a seventh aspect of the present invention, the control means transmits: to the tactual sensation presenting means, an operation instruction of giving the tactual stimulation by moving the tactual sensing unit with the tactual sensing unit contacting the predetermined body part, and to the visual sensation presenting means, video data of presenting, with the tactual-sensing-unit pseudo image being superimposed on the bodily pseudo image in the virtual space, a motional video picture in which the tactual-sensing-unit pseudo image moves by a travel distance different from an actual travel distance of the tactual sensing unit, thereby giving a visual stimulation to the user.

According to an eighth aspect of the present invention, the control means transmits: to the tactual sensation presenting means, an operation instruction of giving the tactual stimulation by causing the tactual sensing unit to contact/non-contact the predetermined body part, and to the visual sensation presenting means, video data of presenting a motional video picture in which the tactual-sensing-unit pseudo image is superimposed on the bodily pseudo image in the virtual space when the tactual sensing unit is in a non-contact state with the predetermined body part, and the tactual-sensing-unit pseudo image is moved apart from the bodily pseudo image when the tactual sensing unit is in a contact state with the predetermined body part, thereby giving the visual stimulation.

According to a ninth aspect of the present invention, the control means transmits: to the tactual sensation presenting means, an operation instruction of halting the tactual sensing unit with the tactual sensing unit contacting the predetermined body part in order to keep giving the tactual stimulation, and to the visual sensation presenting means, video data of presenting a motional video picture in which the tactual-sensing-unit pseudo image displayed in the virtual space moves in a predetermined direction, thereby giving the visual stimulation.

According to a tenth aspect of the present invention, the control means transmits: to the tactual sensation presenting means, an operation instruction of moving the tactual sensing unit with the tactual sensing unit contacting the predetermined body part in order to give the tactual stimulation, and to the visual sensation presenting means, video data of presenting a motional video picture in which the bodily pseudo image is moved in the predetermined direction with the tactual-sensing-unit pseudo image displayed in the virtual space standing still, thereby giving the visual stimulation.

According to an eleventh aspect of the present invention, the tactual sensation presenting means and the visual sensation presenting means are provided on a casing.

### Effect of the Invention

According to the first and sixth aspects of the present invention, there are provided a sensation presenting system and a sensation presenting device which can allow a user to perceive a desired tactual stimulation based on a virtual bodily pseudo image recognized through a visual sensation.

According to the second and seventh aspects of the sensation presenting system and the sensation presenting device of the present invention, even if the travel distance of the tactual sensing unit differs from the travel distance of the tactual-sensing-unit pseudo image in the virtual space, it is possible to allow the user to perceive a tactual stimulation as if the tactual sensing unit is moving by a travel distance corresponding to the travel distance of the tactual-sensing-unit pseudo image in the virtual space.

According to the third and eighth aspects of the sensation presenting system and the sensation presenting device of the present invention, even though the tactual sensing unit contacts the predetermined body part in reality, it is possible to allow the user to perceive a tactual stimulation as if the tactual sensing unit is pulling the predetermined body part through a visual stimulation given as the user visually recognizes a motional video picture in which the tactual-sensing-unit pseudo image moves apart from the bodily pseudo image.

According to the fourth and ninth aspects of the sensation presenting system and the sensation presenting device of the present invention, even though the tactual sensing unit stands still in reality, it is possible to allow the user to perceive a tactual stimulation as if the tactual sensing unit is moving like the tactual-sensing-unit pseudo image based on the tactual stimulation and the visual stimulation.

According to the fifth and tenth aspects of the sensation presenting system and the sensation presenting device of the present invention, even though the tactual sensing unit is moving on the predetermined body part with the predetermined body part standing still in reality, it is possible to allow the user to perceive a feeling as if the user himself/herself moves the predetermined body part based on the tactual stimulation by the tactual sensing unit and the motional video picture in which the bodily pseudo image moves with reference to the tactual-sensing-unit pseudo image.

According to the eleventh aspect of the sensation presenting system of the present invention, the tactual sensation presenting means and the visual sensation presenting means both provided on the casing allow the user to perceive a desired tactual stimulation based on the virtual bodily pseudo image recognized through a visual sensation.

### BRIEF DESCRIPTION OF DRAWINGS

FIG. 1 is a schematic diagram showing an overall configuration of a sensation presenting system of the present invention;

FIG. 2 is a schematic diagram showing an overall configuration of a tactual sensing device;

FIG. 3 is a schematic diagram showing how a tactual sensing unit is caused to contact the hand of a user on an installation table;

FIG. 4 is a schematic diagram showing a bodily pseudo image and a tactual-sensing-unit pseudo image both displayed in a virtual space;

FIG. 5 is a schematic diagram showing a bodily pseudo image presented to the user through a reflector and a liquid crystal shutter eyeglass;

FIG. 6 is a schematic diagram showing the overview of the sensation presenting system executing a tracing stimulation illusory process;

FIG. 7 is a schematic diagram showing the overview of the sensation presenting system executing a tapping stimulation illusory process;

FIG. 8 is a schematic diagram showing the overview of the sensation presenting system executing a pseudo tactual sensation generating process;

FIG. 9 is schematic diagram showing the overview of the sensation presenting system executing a movement illusory process;

FIG. 10 is a schematic diagram showing a configuration of a portable terminal device;

FIG. 11 is a schematic diagram showing a configuration of another face of the portable terminal device and a configuration of a side face thereof;

FIG. 12 is a block diagram showing a circuit configuration of the portable terminal device;

FIG. 13 is a schematic diagram showing a bodily pseudo image and a tactual-sensing-unit pseudo image both displayed in a virtual space;

FIG. 14 is a schematic diagram showing a bodily pseudo image according to another embodiment;

FIG. 15 is a schematic diagram showing a tabular image used in a test;

FIG. 16 is a graph showing a subjective evaluation result;

FIG. 17 is a schematic diagram showing a position where an optical fiber holder is attached and a configuration of the optical fiber holder; and

FIG. 18 is a graph showing a brain function measurement result.

### BEST MODE FOR CARRYING OUT THE INVENTION

Embodiments of the present invention will be explained in detail with reference to the accompanying drawings.

### 1. Overall Configuration of Sensation Presenting System

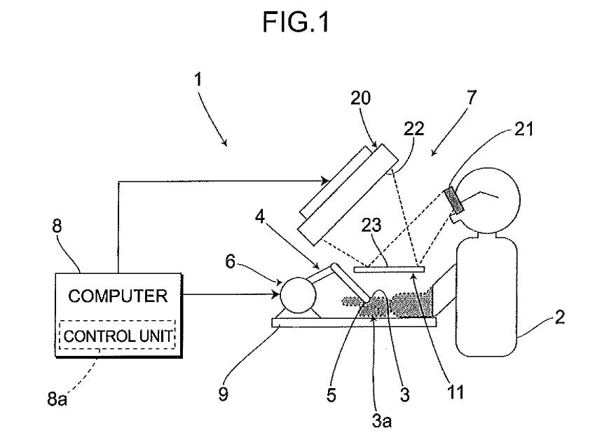

In FIG. 1, reference numeral 1 denotes a sensation presenting system of the present invention, and the sensation presenting system 1 includes a tactual sensing device 6 that causes a tactual sensing unit 5 at the leading end of an arm 4 to contact a back hand 3 of a user 2, an image presenting device 7 that displays a stereoscopic pseudo image (hereinafter, a bodily pseudo image) of the back hand 3 where the tactual sensing device 6 gives a tactual stimulation and a stereoscopic pseudo image (hereinafter, a tactual-sensing-unit pseudo image) of the tactual sensing unit 5 to the user 2, and a computer 8 that controls the tactual sensing device 6 and the image presenting device 7 overall.

The sensation presenting system 1 allows the user 2 to sit down right ahead of an installation table 9 where the tactual sensing device 6 is provided, the tactual sensing device 6 gives a tactual stimulation to a predetermined part of the body of the user 2 (in this case, the back hand 3), and the image presenting device 7 displays a motional image as if a tactual stimulation is given to the predetermined part of the body of the user 2 and provides a stimulation through a user's visual sense (hereinafter, this is referred to as a visual stimulation). The tactual sensing device 6 and the image presenting device 7 may be manually operated by an operator, or may be automatically operated by means of a mechanism. Note that a tactual sense means a sense caused by a biotic body by touching any external object.

In practice, the sensation presenting device 1 is configured to arrange a reflector 11 on a straight line interconnecting the visual point of the user 2 and the back hand 3 as the user 2 sitting down ahead of the installation table 9 disposes, for example, one hand 3a in a space between the installation table 9 and the reflector 11 configuring the image presenting device 7, and the reflector 11 blocks the eyesight of the user 2 and prevents the user 2 from viewing the back hand 3.

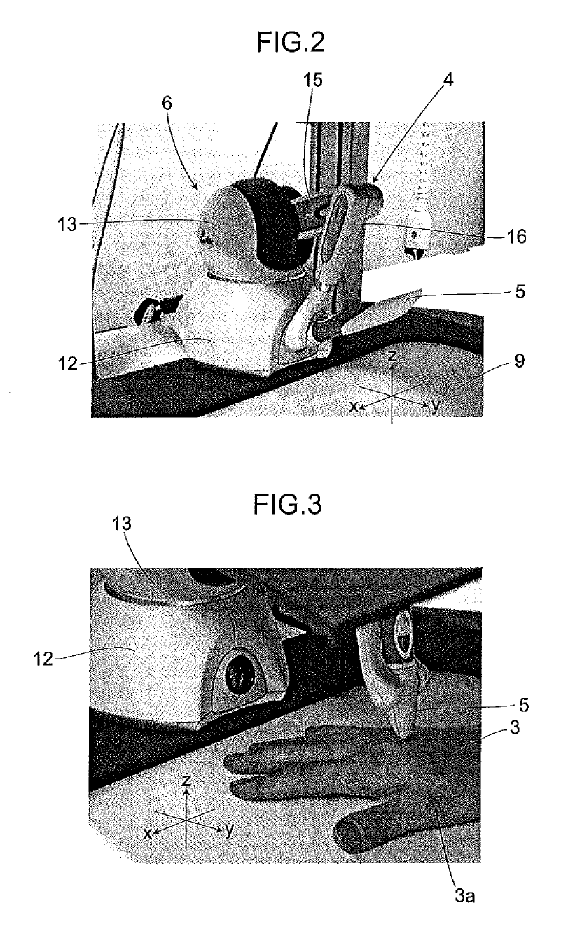

As shown in FIG. 2, the tactual sensing device 6 has a turning unit 13 provided on a base 12 installed on the installation table 9, the turning unit 13 is provided with an arm 4 having the tactual sensing unit 5 at the leading end thereof, and the arm 4 can be moved in the horizontal direction (i.e., the x axis direction) relative to the user 2 by rotating the turning unit 13 along the x axis.

Moreover, the arm 4 employs a configuration in which a first arm member 15 and a second arm member 16 are rotatably linked together, and the one end of the first arm member 15 is provided at the turning unit 13 so as to be freely rotatable along the z axis. The second arm member 16 has one end provided to another end of the first arm member 15 so as to be freely rotatable along the y axis, and has another end where the bar-like tactual sensing unit 5 is provided so as to be freely rotatable along the y axis.

Accordingly, the tactual sensing device 6 allows the tactual sensing unit 5 to move in the vertical direction (i.e., the z axis) relative to the user 2 by turning the first arm member 15 and the second arm member 16, and can move the tactual sensing unit 5 in a direction coming close to or apart from the user 2 (i.e., the y axis), Moreover, the tactual sensing device 6 can move the leading end of the tactual sensing unit 5 in a direction coming close to or apart from the user 2 by turning the tactual sensing unit 5 relative to the second arm member 16.

As the tactual sensing device 6 moves the turning unit 13, the first arm member 15, the second arm member 16, and the tactual sensing unit 5 in this fashion, as shown in FIG. 3, the leading end of the tactual sensing unit 5 is caused to contact the predetermined location of the back hand 3 in order to give a tactual stimulation to the user 2, and gives various tactual stimulations to the user 2 by moving the tactual sensing unit 5 in desired directions.

Conversely, as shown in FIG. 1, the image presenting device 7 includes the reflector 11 arranged at a position with a predetermined height from the installation table 9 in a horizontal manner, a display device 20 provided obliquely above the reflector 11, and a liquid crystal shutter eyeglass 21 attached to the head of the user 2. A motional image displayed on a display unit 22 of the display device 20 is reflected on a mirror unit 23 of the reflector 11, so that the user 2 sitting down ahead of the installation table 9 can view such image through the liquid crystal shutter eyeglass 21.

The display device 20 is connected to the computer 8, and a bodily pseudo image and a tactual-sensing-unit pseudo image (which will be discussed later) stored in the computer 8 beforehand are transmitted thereto as video data, and the display unit 22 displays such bodily pseudo image and tactual-sensing-unit pseudo image. In practice, video data for the right eye and video data for the left eye are input into the display device 20 in a time shearing manner, and the left-eye video recognized by the left eye and the right-eye video recognized by the right eye are alternately displayed in the display unit 22.

The reflector 11 is a tabular member, reflects a bodily pseudo image and a tactual-sensing-unit pseudo image displayed on the display unit 22 of the display device 20 toward the head of the user 2 through the mirror unit 23, so as to allow the user 2 to recognize such images through the liquid crystal shutter eyeglass 21. The image presenting device 7 has the tabular and thin reflector 11 provided above the installation table 9, so that the space where the hand 3a of the user 2 is disposed is secured between the installation table 9 and the reflector 11.

The liquid crystal shutter eyeglass 21 is connected to the computer 8, synchronizes a left-eye shutter arranged ahead of the left eye of the user 2 and a right-eye shutter arranged ahead of the right eye of the user 2 with video data, and allows light to go through and blocks such light, thereby making a difference between a video recognized by the left eye of the user 2 and a video recognized by the right eye of the user 2.

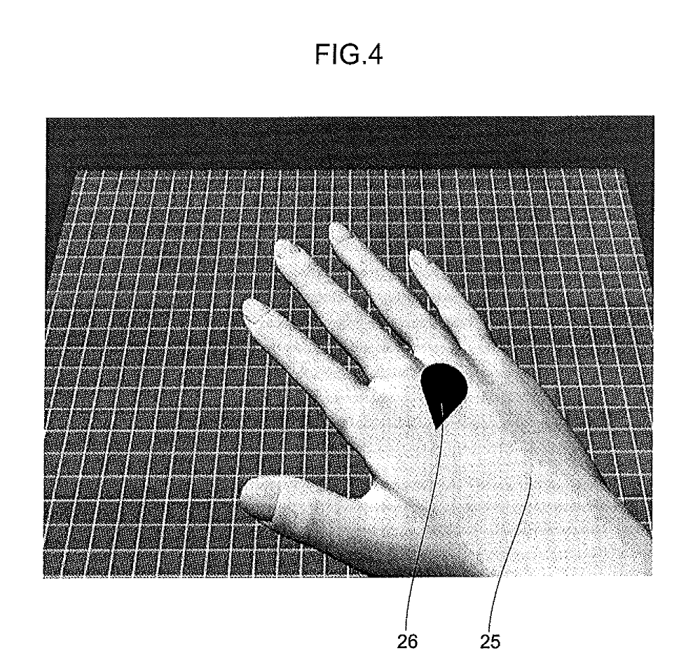

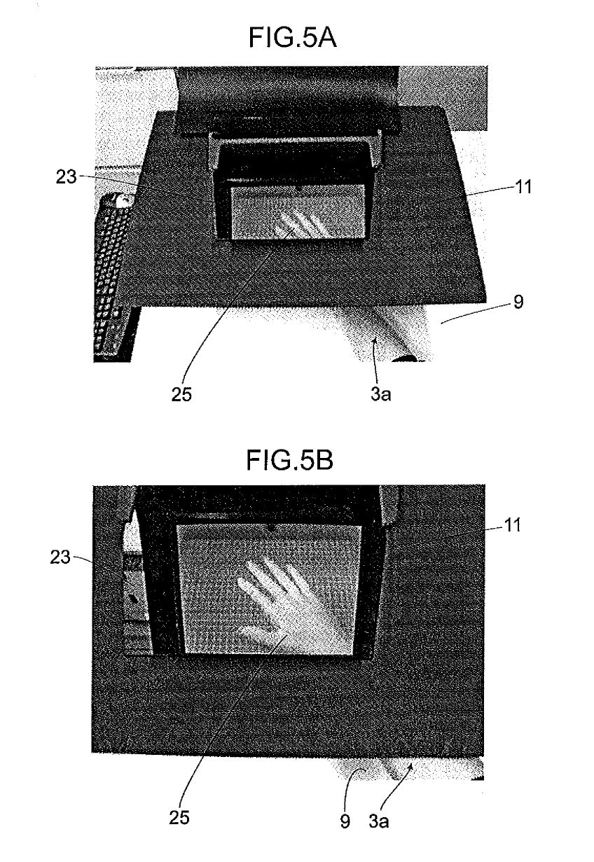

As a result, as shown in FIG. 4, the image presenting device 7 allows the user 2 to visually recognize, in a virtual space, a bodily pseudo image 25 that is a stereoscopic pseudo image of the back hand 3, and a tactual-sensing-unit pseudo image 26 that is a stereoscopic pseudo image of the tactual sensing unit 5. Accordingly, the image presenting device 7 allows the user to view and look the bodily pseudo image 25 reflected by the reflector 11 through the liquid crystal shutter eyeglass 21, and as shown in FIGS. 5A and 5B, thereby allowing the user to perceive as if the bodily pseudo image 25 in the virtual space is a part of the body, which gives a realistic sensation and an immersive feeling to the user.

The computer 8 includes a control unit 8a having a non-illustrated CPU (Central Processing Unit), a RAM (Random Access Memory) 46, a ROM (Read Only Memory), etc., and the control unit 8a that is control means comprehensively controls the computer 8.

The control unit 8a transmits video data stored in a non-illustrated memory unit to the display device 20, so that the display device 20 can display a motional video picture that gives a virtual tactual stimulation (hereinafter, referred to as a virtual tactual stimulation) to the user on the display unit 22 with the tactual-sensing-unit pseudo image 26 contacting the bodily pseudo image 25 in the virtual space, and based on such motional video picture, gives a visual stimulation to the user 2 as if a predetermined tactual stimulation is given to the user 2.

At this time, the controller 8a transmits a predetermined operation instruction corresponding to the motional video picture displayed on the display device 20 to the tactual sensing device 6, and the tactual sensing unit 5 of the tactual sensing device 6 is moved in accordance with such operation instruction. More specifically, when receiving a predetermined operation instruction from the computer 8, the tactual sensing device 6 causes the tactual sensing unit 5 to take a simple operation different from the motion video of the tactual-sensing-unit pseudo image 26 presented to the user 2 through his/her visual sensation based on such operation instruction, so that an illusion as if the same tactual stimulation as that of the motion video of the tactual-sensing-unit pseudo image 26 is given is provided to the user.

According to the sensation presenting device 1 of the present embodiment, four operations are executed as operational processes that give an illusion to the user 2 through his/her visual sensation: a tracing stimulation illusory process; a tapping stimulation illusory process; a pseudo tactual sensation generating process; and a movement illusory process. Individual processes will be discussed below in more detail.

### 2. Tracing Stimulation Illusory Process

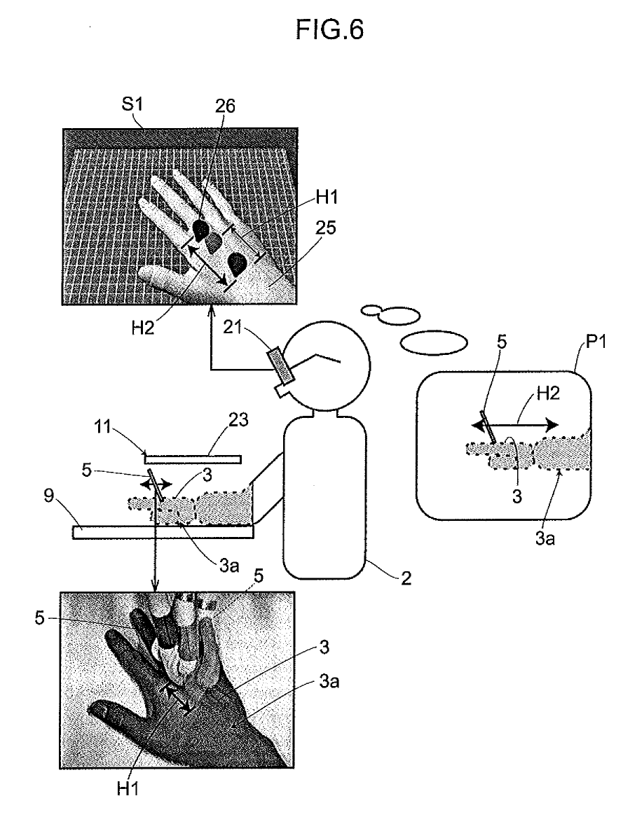

In this case, as shown in FIG. 6, the sensation presenting system 1 allows the user 2 to dispose the one hand 3a thereof between the reflector 11 and the installation table 9, and allows the user 2 to dispose the hand 3a thereof on the installation table 9 so that the back hand 3 of the user 2 is positioned facing the reflector 11. When receiving an instruction for the tracing stimulation illusory process given as an operation instruction from a non-illustrated operation unit, the computer 8 transmits such an instruction to the tactual sensing device 6 (see FIG. 1).

The tactual sensing device 6 causes the tactual sensing unit 5 to contact the back hand 3 of the user 2 disposed on the installation table 9 based on the instruction for the tracing stimulation illusory process, and while maintaining this condition, periodically moves the tactual sensing unit 5 in a direction coming apart from/coming close to the user 2, thereby periodically executing an operation of “tracing” the back hand 3 of the user 2 by the tactual sensing unit 5 (see FIG. 6).

At this time, the computer 8 obtains respective positional data of the turning unit 13, the arm 4, and the tactual sensing unit 5 of the tactual sensing device 6, and specifies coordinate positions of the tactual sensing unit 5 on the x axis, the y axis, and the z axis based on the positional data. Accordingly, the computer 8 causes the control unit 8a to generate video data including the display position of the tactual-sensing-unit pseudo image 26 adjusted based on the specified coordinate positions of the tactual sensing unit 5, and transmits the video data to the display device 20.

Hence, based on such video data, the display device 20 displays the bodily pseudo image 25 stereoscopically representing the back hand 3 on the display unit 22, and displays the tactual-sensing-unit pseudo image 26 at a display position corresponding to the coordinate positions of the tactual sensing unit 5 in the virtual space.

Accordingly, the image presenting device 7 causes the user 2 to visually recognize the bodily pseudo image 25 and the tactual-sensing-unit pseudo image 26 both displayed on the display device 20 through the reflector 11 and the liquid crystal shutter eyeglass 21, thereby giving the user an illusion as if he/she directly views and looks his/her own back hand 3 and the tactual sensing unit 5.

At this time, in a motional video picture Si presented to the user 2 through the liquid crystal shutter eyeglass 21, with the tactual-sensing-unit pseudo image 26 being superimposed on the bodily pseudo image 25, an operation is executed such that the tactual-sensing-unit pseudo image 26 periodically moves in a direction coming apart from/coming close to the user 2 at a timing at which the tactual sensing unit 5 moves, and the tactual-sensing-unit pseudo image 26 gives a virtual tactual stimulation to the bodily pseudo image 25. Moreover, in the motional video picture S1, the tactual-sensing-unit pseudo image 26 moves faster than the actual speed of the movement of the tactual sensing unit 5, and the tactual-sensing-unit pseudo image 26 moves so that a travel distance H2 thereof is longer than a travel distance H1 that the tactual sensing unit 5 actually moves relative to the back hand 3.

In this fashion, the sensation presenting system 1 gives a tactual stimulation to the user like tracing the back hand 3 of the user 2 by the tactual sensing unit 5, while at the same time, presents the user 2 the motional video picture S1 in which the tactual-sensing-unit pseudo image 26 moves by the travel distance H2 different from and longer than the actual travel distance H1 of the tactual sensing unit 5.

Thus way, according to the sensation presenting system 1, even though the actual travel distance HI of the tactual sensing unit 5 is shorter than the travel distance H2 in the motional video picture S1, a perception P1 that is comprehensively perceived by the user 2 based on a tactual stimulation and a visual stimulation can be made as if the tactual sensing unit 5 moves by the travel distance H2 longer than the travel distance H1 in reality.

### 3. Tapping Stimulation Illusory Process

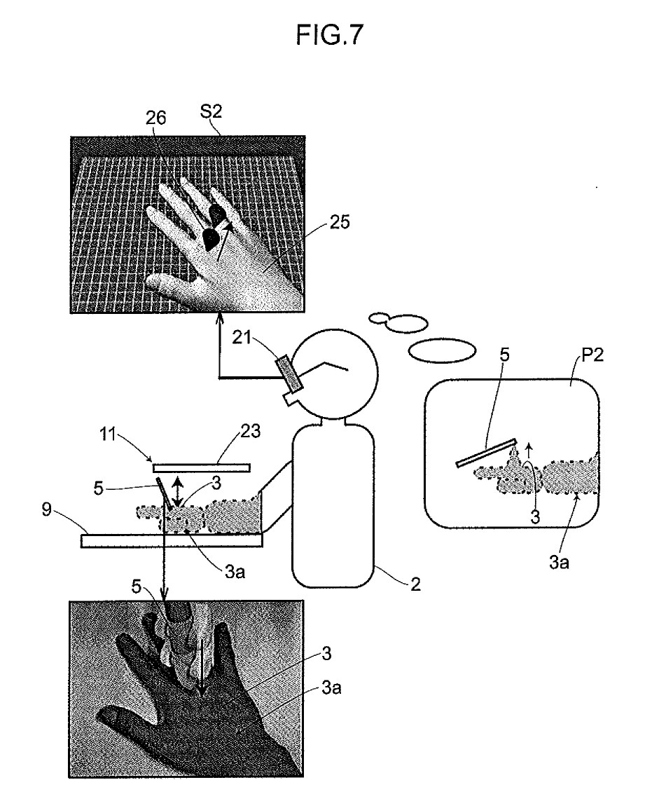

Next, as shown in FIG. 7, the sensation presenting system 1 allows the user 2 to dispose the one hand 3a thereof between the reflector 11 and the installation table 9, and allows the user 2 to dispose the hand 3a thereof on the installation table 9 so that the back hand 3 of the user 2 is positioned facing the reflector 11. When receiving an instruction for the tapping stimulation illusory process given as an operation instruction from the non-illustrated operation unit, the computer 8 transmits such an instruction to the tactual sensing device 6.

Based on the instruction for the tapping stimulation illusory process from the computer 8, the tactual sensing device 6 causes the tactual sensing unit 5 to contact the back hand 3 of the user 2 disposed on the installation table 9, moves the tactual sensing unit 5 apart from the back hand 3 to be in a non-contact state, and periodically executes an operation like “tapping” the back hand 3 of the user 2 by the tactual sensing unit 5.

Moreover, the computer 8 obtains respective positional data of the turning unit 13, the arm 4, and the tactual sensing unit 5 of the tactual sensing device 6, and specifies coordinate positions of the tactual sensing unit 5 on the x axis, the y axis, and the z axis based on such positional data. Accordingly, the computer 8 causes the control unit 8a to generate video data including the display position of the tactual-sensing-unit pseudo image 26 adjusted based on the specified coordinate positions of the tactual sensing unit 5, and transmits such video data to the display device 20.

Hence, based on such video data, the display device 20 displays the bodily pseudo image 25 stereoscopically representing the back hand 3 on the display unit 22, and the tactual-sensing-unit pseudo image 26 is displayed at a display position corresponding to the coordinate positions of the tactual sensing unit 5 in the virtual space.

Accordingly, the image presenting device 7 causes the user 2 to visually recognize the bodily pseudo image 25 and the tactual-sensing-unit pseudo image 26 displayed on the display device 20 through the reflector 11 and the liquid crystal shutter eyeglass 21, thereby giving the user 2 an illusion as if the he/she directly views and looks his/her own back hand 3 and the tactual sensing unit 5.

At this time, in a motional video picture S2 presented to the user 2 through the liquid crystal shutter eyeglass 21, an operation is executed such that the tactual-sensing-unit pseudo image 26 overlaps the bodily pseudo image 25 and moves in the vertical direction being delayed from a timing at which the tactual sensing unit 5 actually moves in the vertical direction, and the tactual-sensing-unit pseudo image 26 gives a virtual tactual stimulation to the bodily pseudo image 25, That is, according to the motional image 82, when the tactual sensing unit 5 contacts the back hand 3, the tactual-sensing-pseudo image 26 moves apart from the bodily pseudo image 25, and when the tactual sensing unit 5 moves apart from the back hand 3 and becomes a non-contact state, the tactual-sensing-unit pseudo image 26 contacts the bodily pseudo image 25.

In this fashion, the sensation presenting system 1 gives the user a tactual stimulation as if the tactual sensing unit 5 taps the back hand 3 of the user 2, and at an instant when the tactual sensing unit 5 taps the back hand 3 of the user 2 and a tactual stimulation is given to the user, the motional video picture S2 in which the tactual-sensing-unit pseudo image 26 moves apart from the bodily pseudo image 25 is presented to the user 2.

Thus way, according to the sensation presenting system 1, even though the tactual sensing unit 5 taps the back hand 3 in reality, a perception P2 that is comprehensively perceived by the user based on a tactual stimulation and a visual stimulation can be made as if the tactual sensing unit 5 pulls the back hand 3.

### 4. Pseudo Tactual Sensation Generating Process

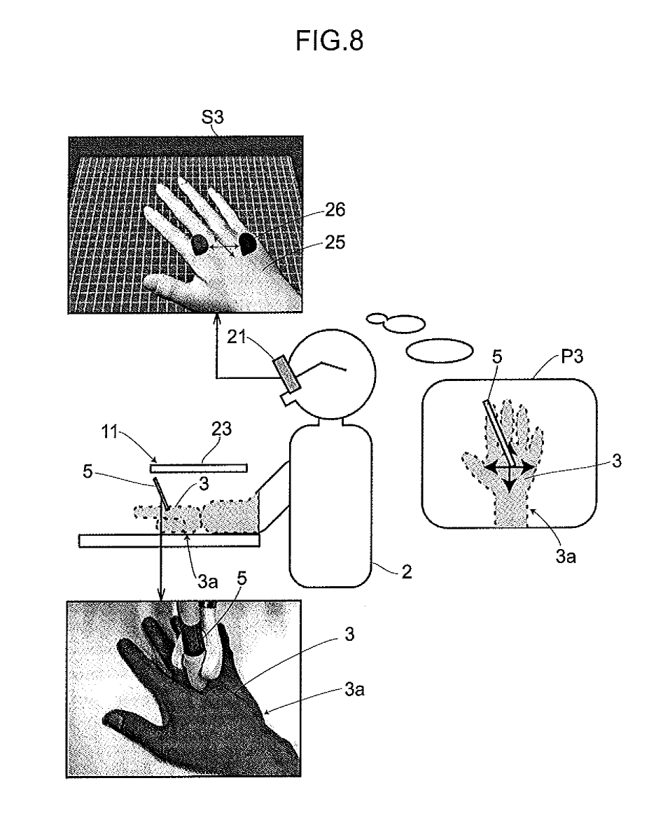

Next, as shown in FIG. 8, the sensation presenting system 1 allows the user 2 to dispose the one hand 3a thereof between the reflector 11 and the installation table 9, and allows the user 2 to dispose the hand thereof on the installation table 9 so that the back hand 3 of the user 2 is positioned facing the reflector 11. When receiving an instruction for the pseudo tactual sensation generating process is given as an operation instruction from a non-illustrated operation unit, the computer 8 transmits such an instruction to the tactual sensing device 6.

Based on the instruction for the pseudo tactual sensation generating process from the computer 8, the tactual sensing device 6 executes an operation of halting the tactual sensing unit 5 with the tactual sensing unit being depressed against the back hand 3 of the user 2 disposed on the installation table 9.

Moreover, the computer 8 obtains respective positional data of the turning unit 13, the arm 4, and the tactual sensing unit 5 of the tactual sensing device 6, and specifies coordinate positions of the tactual sensing unit 5 on the x axis, the y axis, and the z axis based on such positional data. Accordingly, the computer 8 causes the control unit 8a to generate video data including the display position of the tactual-sensing-unit pseudo image 26 adjusted based on the specified coordinate positions of the tactual sensing unit 5, and transmits such video data to the display device 20.

Hence, based on such video data, the display device 20 displays the bodily pseudo image 25 stereoscopically representing the back hand 3 on the display unit 22, and displays the tactual-sensing-unit pseudo image 26 at a display position corresponding to the coordinate positions of the tactual sensing unit 5 in the virtual space. At this time, in a motional video picture S3 presented to the user 2 through the liquid crystal shutter eyeglass 21, an operation is executed such that the tactual-sensing-unit pseudo image 26 moves in a direction coming apart from/coming close to the user 2, and moves in the horizontal direction relative to the user 2, i.e., in the crosswise direction, and the tactual-sensing-unit pseudo image 26 gives a virtual tactual stimulation to the bodily pseudo image 25.

In this fashion, the sensation presenting system 1 halts the tactual sensing unit 5 with the tactual sensing unit contacting a point of the back hand 3 of the user 2 in order to give a tactual stimulation, while at the same time, presents the user 2 the motional video picture S3 in which the tactual-sensing-unit pseudo image 26 moves crosswise relative to the bodily pseudo image 25.

Thus way, according to the sensation presenting system 1, even though the tactual sensing unit 5 stands still while contacting the back hand 3 in reality, a perception P3 that is comprehensively perceived by the user 2 based on a tactual stimulation and a visual stimulation can be made as if the tactual sensing unit 5 moves crosswise over the back hand 3.

### 5. Movement Illusory Process

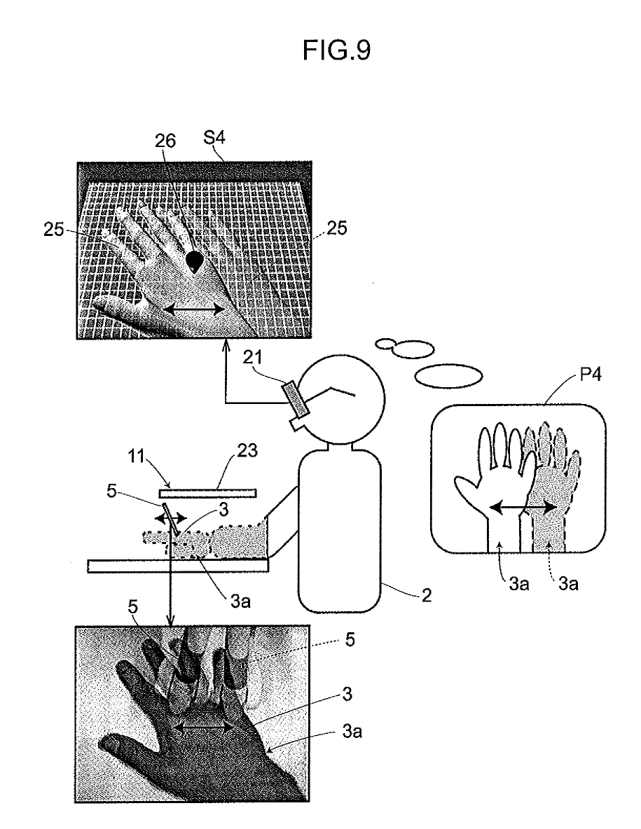

Next, as shown in FIG. 9, the sensation presenting system 1 allows the user 2 to dispose the one hand 3a thereof between the reflector 11 and the installation table 9, and allows the user 2 to dispose the hand 3a thereof on the installation table 9 so that the back hand 3 of the user 2 is positioned facing the reflector 11. When receiving an instruction for the movement illusory process given as an operation instruction from the non-illustrated operation unit, the computer 8 transmits such an instruction to the tactual sensing device 6.

The tactual sensing device 6 depresses the tactual sensing unit 5 against the back hand 3 of the user 2 disposed on the installation table 9 based on the instruction for the movement illusory process from the computer 8, and while maintaining this condition, periodically moves the tactual sensing unit 5 in the horizontal direction relative to the user 2, thereby periodically executing an operation of “tracing” the back hand 3 of the user 2 by the tactual sensing unit 5.

At this time, the computer 8 obtains respective positional data of the turning unit 13, the arm 4, and the tactual sensing unit 5 of the tactual sensing device 6, and specifies coordinate positions of the tactual sensing unit 5 on the x axis, the y axis, and the z axis based on the positional data. Accordingly, the computer 8 causes the control unit 8a to generate video data including the display position of the tactual-sensing-unit pseudo image 26 adjusted based on the specified coordinate positions of the tactual sensing unit 5, and transmits the video data to the display device 20.

Hence, based on such video data, the display device 20 displays the bodily pseudo image 25 stereoscopically representing the back hand 3 on the display unit 22, and displays the tactual-sensing-unit pseudo image 26 at a display position corresponding to the coordinate positions of the tactual sensing unit 5 in the virtual space.

Accordingly, the image presenting device 7 causes the user 2 to visually recognize the bodily pseudo image 25 and the tactual-sensing-unit pseudo image 26 both displayed on the display device 20 through the reflector 11 and the liquid crystal shutter eyeglass 21, thereby giving the user an illusion as if he/she directly views and looks his/her own back hand 3 and the tactual sensing unit 5.

At this time, in a motional video picture S4 presented to the user 2 through the liquid crystal shutter eyeglass 21, with the tactual-sensing-unit pseudo image 26 being superimposed on the bodily pseudo image 25, an operation is executed such that the bodily pseudo image 25 periodically moves in the horizontal direction relative to the user 2 with reference to the tactual-sensing-unit pseudo image 16 at a timing at which the tactual sensing unit 5 moves, and the tactual-sensing-unit pseudo image 26 gives a virtual tactual stimulation to the bodily pseudo image 25.

In this fashion, the sensation presenting system 1 gives a tactual stimulation to the user like “tracing” the back hand 3 of the user 2 by the tactual sensing unit 5, while at the same time, presents the user 2 the motional video picture S4 in which the bodily pseudo image 25 moves in the horizontal direction relative to the user with reference to the tactual-sensing-unit pseudo image 26 in synchronization with the motion of the tactual sensing unit 5.

Thus way, according to the sensation presenting system 1, even though the tactual sensing unit 5 traces the back hand 3 in reality and the back hand 3 itself remains still, a perception P4 that is comprehensively perceived by the user 2 based on a tactual stimulation and a visual stimulation can be made as if the user 2 himself/herself moves the back hand 3 in the horizontal direction.

### 6. Working And Effect

With the above-explained configuration, the sensation presenting system 1 causes the image presenting device 7 to present the user 2 a motional video picture including the bodily pseudo image 25 stereoscopically representing the back hand 3 of the user 2 in the virtual space and the tactual-sensing-unit pseudo image 26 three-dimensionally movable in the virtual space, thereby causing the user to perceive as if the bodily pseudo image 25 is his/her real hand, which enhances a realistic sensation and an immersive feeling.

Accordingly, the sensation presenting system 1 allows the user 2 to visually recognize a motional video picture in which the tactual-sensing-unit pseudo image 26 gives a virtual tactual stimulation to the bodily pseudo image 25 displayed on the image presenting device 7, thereby giving a sensation to the user as if a tactual stimulation corresponding to the virtual tactual stimulation is actually given to the back hand 3 of the user 2.

Moreover, as the tracing stimulation illusory process, the sensation presenting system 1 causes the tactual sensing unit 5 of the tactual sensing device 6 to periodically reciprocate with the tactual sensing unit contacting the back hand 3 of the user 2 in order to give a tactual stimulation to the user 2, while at the same time, displays a motional video picture on the display device 20 in which the tactual-sensing-unit pseudo image 26 periodically reciprocates over the bodily pseudo image 25 in synchronization with the actual movement of the tactual sensing unit 5 in order to give a virtual tactual stimulation to the user, thereby giving a visual stimulation to the user 2.

At this time, even if the travel distance H1 of the tactual sensing unit 5 is made shorter than the travel distance H2 of the tactual-sensing-unit pseudo image 26 in the virtual space, the sensation presenting system 1 can cause the user to perceive, based on a tactual stimulation and a visual stimulation, a tactual stimulation corresponding to a virtual tactual stimulation as if the tactual sensing unit 5 moves by the travel distance H2 corresponding to the travel distance H2 of the tactual-sensing-unit pseudo image 26 in the virtual space.

Furthermore, as the tapping stimulation illusory process, the sensation presenting system 1 causes the tactual sensing unit 5 of the tactual sensing device 6 to periodically contact/noncontact the back hand 3 of the user 2, and periodically gives a tactual stimulation to the user 2 by the tactual sensing unit 5, At this time, the image presenting device 7 displays a motion image on the display device 20 in which the tactual-sensing-unit pseudo image 26 moves apart from the bodily pseudo image 25 when the tactual sensing unit 5 contacts the back hand 3 and the tactual-sensing-unit pseudo image 26 contacts the bodily pseudo image 25 and gives a virtual tactual stimulation when the tactual sensing unit 5 moves apart from the back hand 3 and becomes a noncontact condition, and the sensation presenting system allows the user to visually recognize such a motional video picture.

Accordingly, the sensation presenting system 1 can allow the user 2 to perceive a tactual stimulation corresponding to a virtual tactual stimulation as if the tactual sensing unit 5 is pulling the back hand 3 even though the tactual sensing unit 5 is tapping the back hand 3 in reality based on a visual stimulation given to the user by visually recognizing a motional video picture in which the tactual-sensing-unit pseudo image 26 moves apart from the bodily pseudo image 25.

Still further, as the pseudo tactual sensation generating process, the sensation presenting system 1 halts the tactual sensing unit 5 of the tactual sensing device 6 with the tactual sensing unit contacting the back hand 3 of the user 2 in order to continuously give a tactual stimulation to the user 2, while at the same time, displays a motional video picture on the display device 20 in which the tactual-sensing-unit pseudo image 26 moves in the predetermined direction like tracing the bodily pseudo image 25 in order to give a virtual tactual stimulation, and causes the user 2 to visually recognize such a motional video picture.

Accordingly, even though the tactual sensing unit 5 is halting at a point in reality, the sensation presenting system 1 can allow the user 2 to perceive, based on a tactual stimulation and a visual stimulation, a tactual stimulation corresponding to a virtual tactual stimulation as if the tactual sensing unit 5 is moving like the tactual-sensing-unit pseudo image 26.

As explained above, even if the movable range of the tactual sensing unit 5 is narrowed down, the sensation presenting system 1 can create an illusion of a tactual stimulation based on a motional video picture in which the tactual-sensing-unit pseudo image 26 moves, so that the sensation presenting system can allow the user 2 to perceive a predetermined tactual stimulation, while at the same time, narrow down the movable range of the tactual sensing unit 5, resulting in the reduction of an installation space by what corresponds to such narrow-down, thereby simplifying the overall configuration of the device.

Moreover, as the movement illusory process, the sensation presenting system 1 gives a tactual stimulation to the user 2 by periodically reciprocating the tactual sensing unit 5 of the tactual sensing device 6 with the back hand 3 of the user 2 remaining still and the tactual sensing unit contacting the back hand 3, and displays, on the display device 20, a motional video picture in which the bodily pseudo image 25 periodically moves in synchronization with the motion of the tactual sensing unit 5 in order to give a virtual tactual stimulation with the tactual-sensing-unit pseudo image 26 remaining still, thereby giving a visual stimulation to the user 2.

Accordingly, even though the back hand 3 remains still and the tactual sensing unit 5 is moving like tracing the back hand 3 in reality, the sensation presenting system I can allow the user 2 to perceive, based on a tactual stimulation by the tactual sensing unit 5 and a motional video picture in which the bodily pseudo image 25 moves with reference to the tactual-sensing-unit pseudo image 26, a tactual stimulation corresponding to a virtual tactual stimulation as if the user 2 himself/herself moves the back hand 3 in the horizontal direction.

As explained above, the sensation presenting system 1 changes a perception of a tactual stimulation actually given to the user 2, and allows the user 2 to perceive a tactual stimulation that is not given to the user in reality, Therefore, the sensation presenting system of the present invention can be applied to fields of entertainment, welfare and medical services, etc.

It is expected that such presentation of a combination of a motional video picture that is a visual stimulation and a tactual stimulation can expand the range of expression in the field of interactive digital contents, such as a computer game and a virtual reality. Hence, the sensation presenting system 1 can be applied as an information presenting system by aesthesia alternatives in the field of welfare and medical services, assisting of a rehab and improvement of the effect thereof, and a training system of a clinical examination and a surgery for doctors. In the field of education, it can be applied to development of contents by presenting information using multisensory stimulations.

According to the above-explained configuration, the tactual sensing unit 5 gives a tactual stimulation to the back hand 3 of the user 2, while at the same time, the bodily pseudo image 25 and the tactual-sensing-unit pseudo image 26 are displayed in the virtual space, and a motional video picture is presented in which the tactual-sensing-unit pseudo image 26 gives a virtual tactual stimulation to the bodily pseudo image 25 in order to give a visual stimulation to the user. When such a visual stimulation is given to the user, a motional video picture different from a motion that the tactual sensing unit 5 gives the tactual stimulation to the back hand 3 is displayed, and based on the visual stimulation given by the motional video picture and the tactual stimulation given by the tactual sensing unit 5, the user 2 is allowed to perceive a tactual stimulation corresponding to the virtual tactual stimulation, so that the user 2 is enabled to perceive a desired tactual stimulation based on the virtual bodily pseudo image 25 recognized through a visual sensation,

It is expected that such a sensation presenting system 1 can be applied to various fields, For example, when it is used for a rehab, by executing the above-explained “5. movement illusory process” to the user 2 who is unable to move his/her hand, the user can get an illusion as if he/she moves the hand, thereby improving the motivation of the user 2 at the time of rehab.

### 7. Second Embodiment

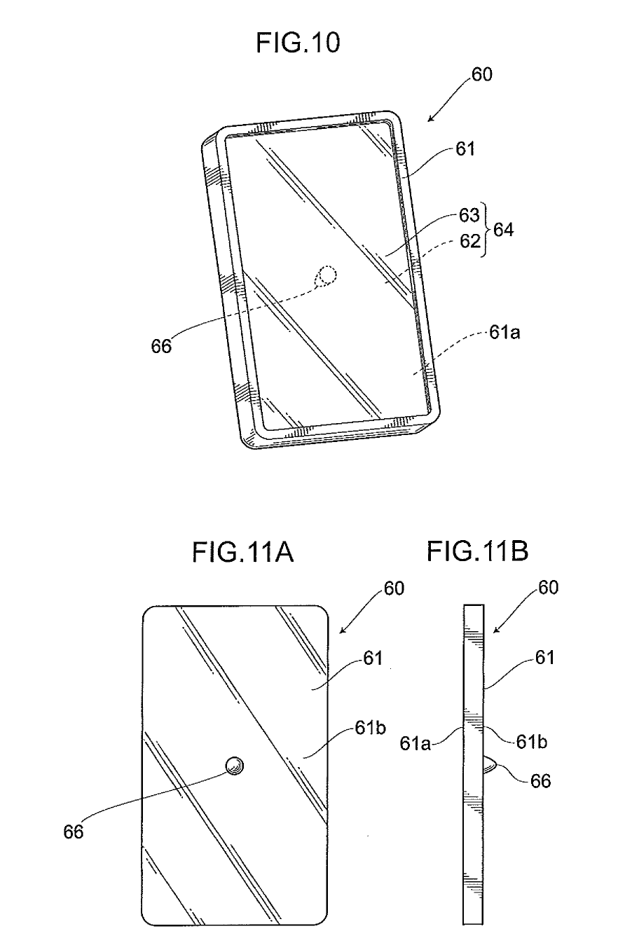

In FIG. 10, reference numeral 60 stands for a portable terminal device that is a sensation presenting system of a second embodiment, and the portable terminal device is in a rectangle shape that can be held by one hand of a user overall. The portable terminal device includes a casing 61 designed so as to have an external shape with a predetermined thickness, and the user can carry the casing 61 by one hand.

The casing 61 has a display unit 64 provided on the whole area of one face 61a of the casing and including a touch panel 62 operable as the user touches by a finger, and an LCD (Liquid Crystal Display) 63. As a power is turned on, the display unit 64 displays a main screen. The main screen includes, depending on a control program run by a control unit to be discussed later, menu items (not illustrated) for executing various functions, such as a calling function, a data communication function, a scheduling function, a calendar function, a game function, and a navigation function.

In practice, as shown in FIGS. 11A and 11B, the portable terminal device 60 has another face 61b opposite to the one face 61a and formed in a planar shape, and with another face 61b being held on the palm of the one hand of the user, for example, the thumb of the one hand abuts a predetermined side face of the casing 61, and the index finger, the middle finger, the fourth finger, and the little finger abut another side face different from the predetermined side face, so that the casing is held by the user. In this condition, the portable terminal device 60 allows the user to visually recognize the content displayed on the display unit 64, and when the user depresses a desired menu item or the like on the display unit 64 by a finger of another hand, executes various functions.

In addition to such a configuration, the casing 61 is provided with a tactual sensation presenting unit 66 protruding from another face 61B at a predetermined location of another face 61b. The tactual sensation presenting unit 66 is provided near the center of another face 61B of the casing 61, and when another face 61B of the casing 61 is mounted on the palm of the user, the leading end of the tactual sensation presenting unit which is the tactual sensing unit abuts the palm of the user, and gives a tactual stimulation to the user. According to the present embodiment, the tactual sensation presenting unit 66 is formed in a conical shape having a leading end slightly rounded, and as the leading end abuts the palm of the user, the tactual sensation presenting unit provides a tactual stimulation to the user.

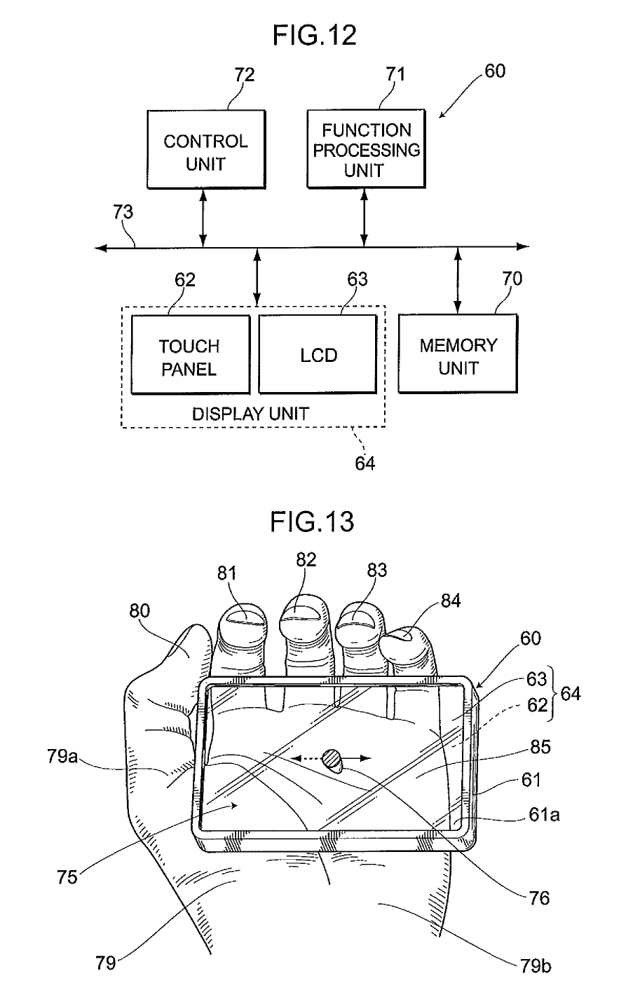

The portable terminal device 60 utilizes the same principle as that of the “4. pseudo tactual sensation generating process” of the first embodiment, and causes the user to feel a tactual stimulation as if a tactual-sensing-unit pseudo image (which will be discussed later) displayed on the display unit 64 moves on the palm of the user based on a tactual stimulation given to the user by the tactual sensation presenting unit 66 and a visual stimulation given to the user by the display unit 64, In practice, as shown in FIG. 12, the portable terminal device 60 has the display unit 64 including the touch panel 62 and the LCD 63, a memory unit 70, and a function processing unit 71 that includes a circuit necessary for executing various functions, such as a call function and a data communication function, connected to a control unit 72 through a bus 73. The control unit 72 includes non-illustrated CPU (Central Processing Unit), RAM (Random Access Memory), ROM (Read Only Memory), etc., and reads various programs, such as a basic program and a sensation presenting process program, stored in the ROM in the RAM as needed, in accordance with various instructions, thereby executing a predetermined process.

As shown in FIG. 13, the memory unit 70 pre-stores motional video picture data including a bodily pseudo image 75 that represents the palm of the user which cannot be directly viewed because it is blocked by the casing 61 when the user holds the casing 61 by one hand and views the display unit 64, and a tactual-sensing-unit pseudo image 76 displayed so as to be superimposed on the bodily pseudo image 75. The control unit 72 reads motional video picture data stored in the memory unit 70 and displays such a motional video picture on the display unit 64, thereby causing the user to get an illusion as if the user is enabled to visually recognize, in the frame of the display unit 64, a palm 79 of the user that cannot be directly viewed because of the casing 61.

In practice, according to the present embodiment, it is expected that with another face 61b of the casing 61 being held on the palm 79 of the one hand of the user, a thenar part 79a, a wrist 79b, a thumb 80, an index finger 81, a middle finger 82, a fourth finger 83, and a little finger 84 of the palm 79 of the one hand abut respective predetermined positions of the side face and the casing is held by the user. At this time, an antihenar part 85, the thenar part 79a, and respective bases of the index finger 81, the middle finger 82, the fourth finger 83, and the little finger 84 among the palm 79 of the user are hidden in the frame of the display unit 64.

Hence, the display unit 64 displays the bodily pseudo image 75 representing respective bases of the index finger 81, the middle finger 82, the fourth finger 83, and the little finger 84 from the antihenar part 85 to the thenar part 79a of the palm 79 of the user hidden by the display unit 64. Accordingly, the portable terminal device 60 causes the user to visually recognize the bodily pseudo image 75 displayed on the display unit 64, thereby giving the user an illusion as if the user can directly view the palm 79 thereof through the frame of the display unit 64.

At this time, the tactual-sensing-unit pseudo image 76 displayed together with the bodily pseudo image 75 has substantially same size as that of the tactual sensation presenting unit 66 (see FIGS. 11A and 11B) provided at another face 61b of the casing 61, is displayed at a position facing the tactual sensation presenting unit 66, and is displayed on the display unit 64 so as to move in a predetermined direction over the bodily pseudo image 75 around the display position facing the tactual sensation presenting unit 66.

The tactual-sensing-unit pseudo image 76 moves, for example, in the horizontal direction over the bodily pseudo image 75 around the initial display position (the position facing the tactual sensation presenting unit 66 of another face 61b in the one face 61a), and is displayed to give the user a virtual tactual stimulation as if the tactual-sensing-unit pseudo image gives a tactual stimulation to the bodily pseudo image 75. With the tactual sensation presenting unit 66 contacting the palm 79 of the user and giving a certain tactual stimulation, the portable terminal device 60 causes the user 2 to visually recognize a motional video picture in which the tactual-sensing-unit pseudo image 76 moves in a predetermined direction relative to the bodily pseudo image 75 through the display unit 64.

Accordingly, as a perception that is comprehensively perceived by the user based on the a tactual stimulation and a visual stimulation, even though the tactual sensation presenting unit 66 remains still and contacts merely one point of the palm 79 in reality, the portable terminal device 60 allows the user to perceive as if the tactual sensation presenting unit 66 moves over the palm 79 along with the motion of the tactual-sensing-unit pseudo image 76.

According to the above-explained configuration, as the portable terminal device 60 displays, on the display unit 64, the bodily pseudo image 75 which stereoscopically represents the palm 79 of the user holding the casing 61 in the virtual space, the portable terminal device can allow the user to perceive as if the bodily pseudo image 75 is his/her own hand, thereby enhancing a realistic sensation and an immersive feeling.

At this time, the portable terminal device 60 displays the tactual-sensing-unit pseudo image 76 in the region of the display unit 64 at a position facing the tactual sensation presenting unit 66 provided at another face 61b, and allows the user to visually recognize a motional video picture in which the tactual-sensing-unit pseudo image 76 moves over the bodily pseudo image 75 around the display position, and the tactual-sensing-unit pseudo image 76 gives a virtual tactual stimulation to the bodily pseudo image 75. Hence, the portable terminal device 60 can give a sensation as if a tactual stimulation corresponding to the virtual tactual stimulation is given to the palm 79 of the user himself/herself based on a visual stimulation.

At this time, even though the tactual sensation presenting unit 66 gives a tactual stimulation only to a point on the palm 79 of the user, the portable terminal device 60 can give the user a sensation corresponding to a tactual stimulation as if the tactual-sensing-unit pseudo image 76 moves over the palm 79 of the user based on the visual stimulation.

Moreover, according to the present embodiment, it is not necessary to make the portable terminal device 60 provided with vibrating means for vibrating the tactual sensation presenting unit 66, moving means for moving the tactual sensation presenting unit 66, and other various driving means, so that the overall configuration of the device can be simplified, and the user can get a sensation as if a tactual stimulation corresponding to the virtual tactual stimulation is given to the user based on the motional video picture displayed on the display unit 64.

According to the above-explained configuration, the tactual sensation presenting unit 66 gives a tactual stimulation to the palm 79 of the user, the bodily pseudo image 75 and the tactual-sensing-unit pseudo image 76 are displayed in the virtual space, and a motional video picture in which the tactual-sensing-unit pseudo image 76 gives a virtual tactual stimulation to the bodily pseudo image 75 is presented to the user. In this condition, when a visual stimulation is given to the user, a motional video picture that is different from the motion that the tactual sensation presenting unit 66 gives a tactual stimulation to the palm 79 is presented. Accordingly, based on the visual stimulation given by the motional video picture and the tactual stimulation given by the tactual sensation presenting unit 66, the portable terminal device 60 allows the user to perceive a tactual stimulation corresponding to the virtual tactual stimulation, thereby allowing the user 2 to perceive a desired tactual stimulation based on the virtual bodily pseudo image 75 recognized through a visual sensation.

Moreover, according to the portable terminal device 60, the casing 61 designed so as to be held by the palm 79 of the one hand of the user is provided with the tactual sensation presenting unit 66 and the display unit 64, which enables the sensation presenting system 1 of the first embodiment to be built in, for example, a cellular phone, a portable gaming machine.

In the above-explained embodiment, as a tactual-sensing-unit pseudo image, a conical tactual-sensing-unit pseudo image 76 is used. The present invention is, however, not limited to this case, and for example, various tactual-sensing-unit pseudo images, such as a bar-like image and a character representing a virtual living thing, can be used. In this case, by substituting the tactual-sensing-unit pseudo image 76 with, for example, a character representing a virtual living thing, the portable terminal device 60 can display a video on the display unit 64 as if the character is moving on the palm 79, thereby giving a visual stimulation to the user. This results in an improvement of the entertainment characteristics of a game or the like of a virtual living thing on the portable terminal device like a cellular phone.

Moreover, in the foregoing embodiment, the explanation was given of a case in which the “4, pseudo tactual sensation generating process” of the first embodiment is applied to the portable terminal device 60. The present invention is, however, not limited to this case, and for example, the portable terminal device may be provided with driving means for vibrating the tactual sensation presenting unit 66 or moving the tactual sensation presenting unit 66 in an arbitrary direction, and may give a desired tactual stimulation to the user based on the same principle as those of the “3. tapping stimulation illusory process” and “2, tracing stimulation illusory process” of the first embodiment.

Furthermore, in the foregoing embodiment, the explanation was given of a case in which the portable terminal device is used with the casing 61 being held on the palm of the one hand. The present invention is, however, not limited to this case, and for example, the casing 61 may be mounted on various body parts, such as an upper arm, and a thigh, and in this case, the display unit 64 displays a bodily pseudo image representing a body part like an upper arm or a thigh where the casing 61 is mounted.

Still further, in the foregoing embodiment, the explanation was given of a case in which the casing 61 is designed so as to have an external shape portable by the palm of the one hand of the user. The present invention is, however, not limited to this case, and for example, a casing having an external shape with various sizes such that the easing can be held by only both hands of the user may be employed.

### 8. Other Embodiments

The present invention is not limited to the foregoing embodiments, and can be changed and modified in various forms. For example, in the foregoing embodiments, as a predetermined body part, a tactual stimulation is given to the back hand 3, but the present invention is not limited to this configuration. For example, a tactual stimulation may be given to various predetermined body parts, such as a lower arm, a lower thigh and a leg, and to plural predetermined body parts. In this case, a pseudo image representing a predetermined body part where the tactual sensing device 6 gives a tactual stimulation is displayed as a bodily pseudo image.

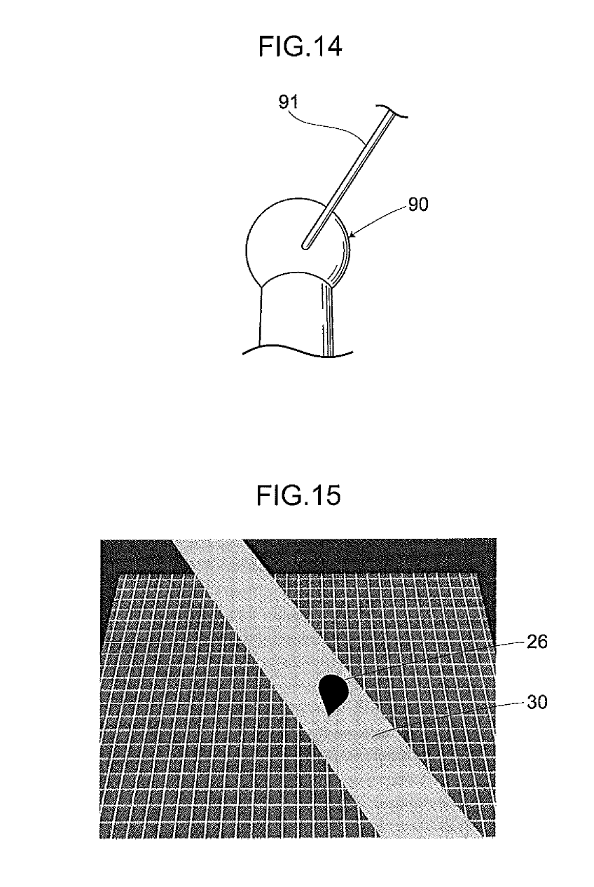

Moreover, in the foregoing embodiments, as the bodily pseudo image corresponding to the predetermined body part, the bodily pseudo image which is stereoscopic and representing the predetermined body part is used. The present invention is, however, not limited to this case, and as far as the user can get an illusion such that an image is like the predetermined body part of the user, as shown in FIG. 14, an image 90 in a shape representing a deformed predetermined body part, or an image with a shape different from that of the predetermined body part may be used as the bodily pseudo image. Note that reference numeral 91 in FIG. 14 stands for a tactual-sensing-unit pseudo image.

Furthermore, in the foregoing embodiments, the explanation was given of a case in which one user 2 is caused to view the display device 20 displaying one bodily pseudo image 25, the user is caused to have an illusion as if the bodily pseudo image 25 is a part of the body of the user himself/herself, and the tactual sensing unit 5 gives a tactual stimulation to the user 2. The present invention is, however; not limited to this case, and for example, a plurality of users may be caused to view the display device 20 displaying plural bodily pseudo images 25, each of the plurality of users may be caused to have an illusion as if each bodily pseudo image 25 is a part of the body of each user himself/herself, and the tactual sensing unit 5 may individually give a tactual stimulation to individual user 2. In this case, various collaborative works by the plural users may be presented.

Still further, in the foregoing embodiments, the explanation was given of a case in which, as a tactual stimulation given by the tactual sensing unit, a tactual stimulation given by the tactual sensing unit 5 touching the skin is used. The present invention is, however, not limited to this case, and for example, instead of the tactual stimulation given to the skin, various tactual stimulations, such as a tactual stimulation by heat, a tactual stimulation by cold feeling, a tactual stimulation by vibration, and a tactual stimulation by electricity, can be used, and a pain or a pleasure may be given to the user 2 through such tactual stimulations.

In the foregoing embodiments, although the explanation was given of a case in which the display device 20 using the liquid crystal shutter eyeglass 21 is used, the present invention is not limited to this case, and for example, a stereoscopic display device of a glass-less type, a display device of a polarization glass type, etc., may be used.

In the foregoing embodiments, as visual sensation presenting means, the reflector 11 is provided at a position with a predetermined height from the installation table 9, a motional video picture output by the display device 20 arranged obliquely above the reflector 11 is reflected by the reflector 11, and the user is allowed to indirectly view the motional video picture through the liquid crystal shutter eyeglass 21, The present invention is, however, not limited to this configuration, and for example, the display device 20 may be arranged at a position with a predetermined height from the installation table 9, and the user may be allowed to directly view the motional video picture through the liquid crystal shutter eyeglass 21.

In the foregoing embodiments, as the visual sensation presenting means, the image presenting device 7 including the reflector 11, the display device 20, and the liquid crystal shutter eyeglass 21 is used. The present invention is, however, not limited to this case, and for example, a head mounted display (HMD: Head Mounted Display) may be used, and in this case, by just attaching the HMD connected to the computer to the head of the user, not only a motional video picture but also a sound corresponding to such a motional video picture can be presented to the user through the HMD,

The sensation presenting system may employ a so-called augmented reality (AR: Augmented Reality) type visual stimulation presenting scheme which uses, as the visual sensation presenting means, a half mirror or a camera-equipped HMD instead of the reflector 11, and which synthesizes the tactual-sensing-unit pseudo image 26 in the virtual space with a predetermined body part (e.g., the back hand 3) in the reality and displays such a synthesized image.

In the foregoing embodiments, the bodily pseudo image 25 stored in the computer 8 beforehand is presented at a predetermined location in the virtual space, but the present invention is not limited to this case. For example, the user may be equipped with a device that obtains a physical exertion like a data glove, and the motion of the user may be represented by a stereoscopic image, or an image of a predetermined body part of the user 2 picked up by image-pickup means may be stored in a database, and the image may be played and presented, and an image of the predetermined body part of the user 2 picked up by the image-pickup means may be presented in real time.

In the foregoing embodiment, the tactual sensing unit 5, the bodily pseudo image 25 and the tactual-sensing-unit pseudo image 26 are moved in the horizontal direction or the like relative to the user through the tracing stimulation illusory process, the tapping stimulation illusory process, the pseudo tactual sensation generating process, and the movement illusory process. The present invention is, however, not limited to this configuration, and for example, the tactual sensing unit 5, the bodily pseudo image 25, and the tactual-sensing-unit pseudo image 26 may be moved in various directions like an oblique horizontal direction.

In the second embodiment, although the casing 61 is formed in a rectangle shape with a size held by the palm of one hand of the user, the present invention is not limited to this case, and the casing may be formed in various shapes, such as a quadrangle shape, and a circular shape to be held by the palm of the one hand of the user.

### 9. EXAMPLES

Next, a test was carried out which caused a user 2 to experience an illusion by giving the user a tactual stimulation and a visual stimulation from the sensation presenting system 1 of the first embodiment of the present invention, and which objectively observed the user based on a subjective evaluation by an illusion intensity and on a brain function measurement through a near infrared spectroscopy (NIRS: Near Infra-red Spectroscopy).

More specifically, using the sensation presenting system 1 shown in FIG. 1, the test was carried out by setting first to three conditions in which combinations of a tactual stimulation and a visual stimulation were changed. The presenting time in each condition was 20 seconds, and a rest time of 20 seconds was set between individual presenting times.

Regarding how to present a stimulation in the first condition (hereinafter, referred to as a synchronous condition), a bodily pseudo image 25 that was a stereoscopic pseudo image of a right hand 3a shown in FIG. 4 was displayed on the display device 20, and a motional video picture in which a tactual-sensing-unit pseudo image 26 moved was displayed. At this time, the tactual sensing device 6 synchronized an operation of giving a tactual stimulation to the back hand 3 by the tactual sensing unit 5 with the motional video picture displayed on the display device 20, thereby making the tactual stimulation consistent with the visual stimulation.

Next, regarding how to present a stimulation in the second condition (hereinafter, referred to as an illusory condition) a motional video picture in which the tactual-sensing-unit pseudo image 26 moved and an operation of giving a tactual stimulation by the tactual sensing unit 5 were synchronized with each other for approximately 10 seconds, the same tactual stimulation and visual stimulation were given, and only the operation of the tactual sensing unit 5 was terminated and halted for 10 seconds with the tactual sensing unit 5 being depressed against the back hand 3.

Regarding how to present a stimulation in the third condition (hereinafter, referred to as a tabular condition), instead of the bodily pseudo image 25, as shown in FIG. 15, an image of a mono-color plate (hereinafter, referred to as a tabular image) 30 was displayed on the display device 20, the motional video picture in which the tactual-sensing-unit pseudo image 26 moved over the tabular image 30 was synchronized with an operation of giving a tactual stimulation by the tactual sensing unit 5 for approximately 10 seconds like the illusory condition, and only the operation of the tactual sensing unit 5 was terminated and halted for 10 seconds with the tactual sensing unit 5 being depressed against the back hand 3.

As the procedure of this test, a test subject was caused to once experience respective stimulation presenting schemes in the synchronous condition, the illusory condition, and the tabular condition, and respective matters of the stimulation presenting schemes in the synchronous condition, the illusory condition, and the tabular condition were explained to the test subject. The orders of respective stimulation presenting schemes in the synchronous condition, the illusory condition, and the tabular condition in the test were set at random. Moreover, three conditions: the synchronous condition; the illusory condition; and the tabular condition were set as a session, and a total of four sessions of stimulation presentation were carried out. In the test, a subjective evaluation through five-score scales (which will be discussed later) was obtained after respective stimulation presentation in the synchronous condition, the illusory condition, and the tabular condition, and a self-observation report after respective stimulation presentation in the synchronous condition, the illusory condition, and the tabular condition was obtained.

Regarding the subjective evaluation, a question “Did you feel a tactual stimulation together with a visual stimulation?” was orally given from a researcher to the test subject, and evaluation was made by letting the test subject to answer the question in oral. More specifically, as the answers of the test subject, the five score scales such that feeling of the test subject to a stimulation to the back hand was divided into five stages: “felt nothing” was one point; “felt slightly” was two points; “felt” was three points; “felt well” was four points; and “felt clearly” was five points and the scores were collected was carried out. The test subject was caused to try the synchronous condition, the illusory condition, and the tabular condition each for four times, and an average (a score) of the subjective evaluation in the trial for each test subject was obtained. Six right-handed males were the test subjects in the test.

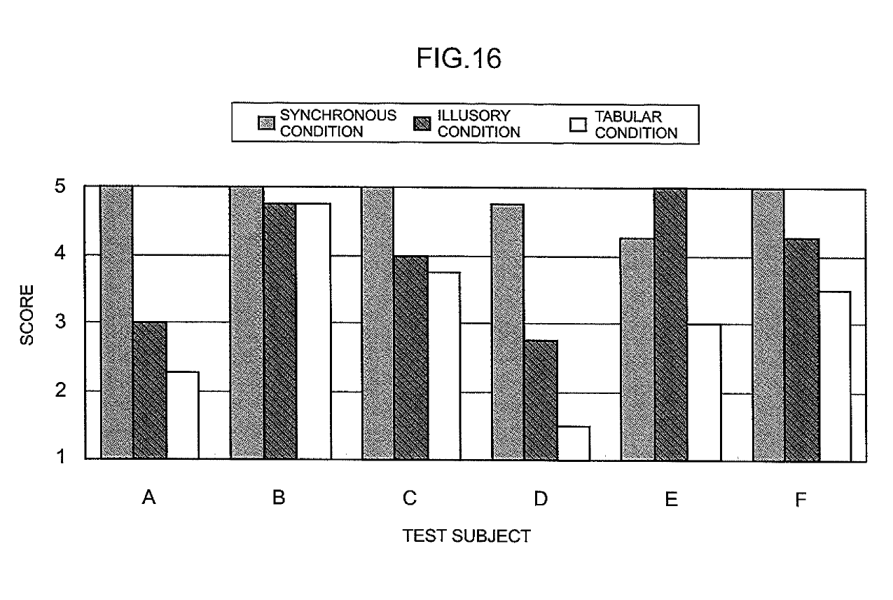

As a result, according to the test, a subjective evaluation result shown in FIG. 16 was obtained. In FIG. 16, test subjects were A, B, C, D, E, and F in the horizontal axis, and the score of each test subject was expressed in the vertical axis. According to this test, although there was a difference in how to feel an illusion, it was confirmed from the subjective evaluation result that the test subject clearly perceived an illusion such that the test subject felt a tactual stimulation from a visual stimulation.

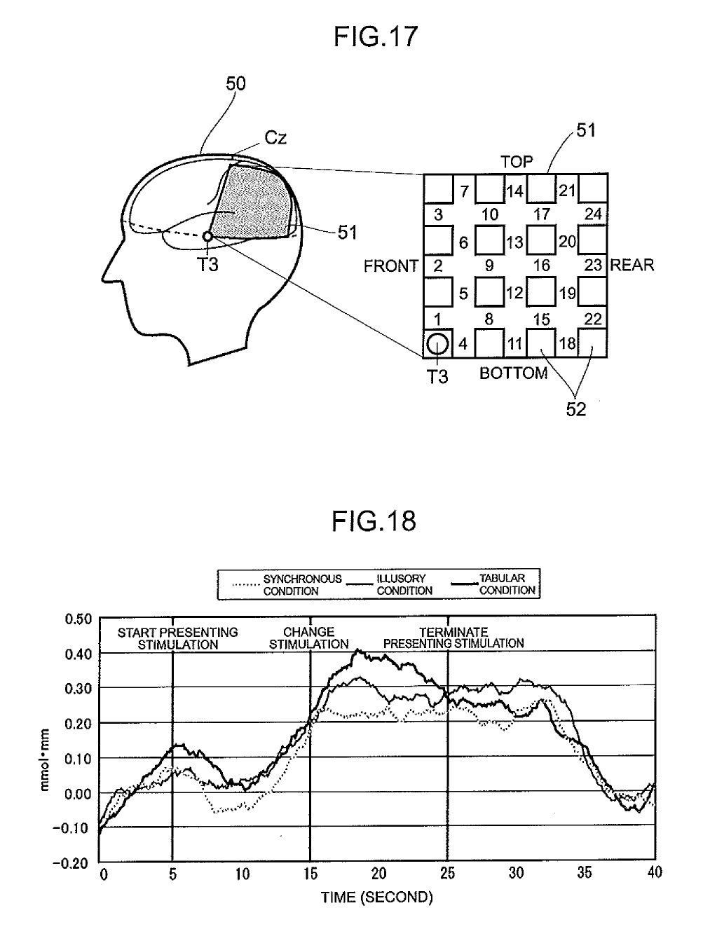

Moreover, according to the test in which the brain function measurement was carried out, as shown in FIG. 17, in order to measure a reaction of the test subject against synchronization of a tactual stimulation with a visual stimulation, a motional video picture, and a tactual stimulation, an optical fiber holder 51 was attached to a portion from the left head lobe of a head 50 of the test subject to the parietal lobe and the occipital lobe, and respective stimulation presentations in the synchronous condition, the illusory condition, and the tabular condition were carried out. Attachment of the optical fiber holder 51 to the head 50 was made with reference to a position T13 defined in the international 10-20 method. In FIG. 17, regions 52 each described like a square represent positions of the optical fiber probe, and are arranged in a matrix pattern with the equal interval. In FIG. 17, the number put on the optical fiber holder 51 indicates a channel.

Through the test, for example, in the case of the test subject B, a brain function measurement result as shown in FIG. 18 was obtained. As shown in FIG. 18, a result that the test subject B felt an illusion in substantially all conditions (the synchronous condition, the illusory condition, and the tabular condition) was obtained. Note that the proximity of the angular gyrus of the 23 ch of the optical fiber holder 51 corresponds to a bodily video.

1. A sensation presenting system comprising:
a tactual sensation presenting means that gives a tactual stimulation to a predetermined body part of a user by a tactual sensing unit; and
a visual sensation presenting means which displays a bodily pseudo image corresponding to the predetermined body part and a tactual-sensing-unit pseudo image corresponding to the tactual sensing unit in a virtual space, and which presents the user a motional video picture in which the tactual-sensing-unit pseudo image gives a virtual tactual stimulation to the bodily pseudo image, thereby giving a visual stimulation to the user,
wherein the visual sensation presenting means presents a motional video picture different from an operation of giving the tactual stimulation to the predetermined body part by the tactual sensing unit, and allows the user to perceive a tactual stimulation corresponding to the virtual tactual stimulation based on the visual stimulation given by the motional video picture and the tactual stimulation given by the tactual sensing unit.

2. The sensation presenting system according to claim 1, wherein
the tactual sensation presenting means gives the tactual stimulation by moving the tactual sensing unit with the tactual sensing unit contacting the predetermined body part, and
the visual sensation presenting means presents, with the tactual-sensing-unit pseudo image being superimposed on the bodily pseudo image in the virtual space, a motional video picture in which the tactual-sensing-unit pseudo image moves by a travel distance different from an actual travel distance of the tactual sensing unit, thereby giving a visual stimulation to the user.

3. The sensation presenting system according to claim 1, wherein
the tactual sensation presenting means gives the tactual stimulation by causing the tactual sensing unit to contact/non-contact the predetermined body part, and
the visual sensation presenting means presents a motional video picture in which the tactual-sensing-unit pseudo image is superimposed on the bodily pseudo image in the virtual space when the tactual sensing unit is in a non-contact state with the predetermined body part, and the tactual-sensing-unit pseudo image is moved apart from the bodily pseudo image when the tactual sensing unit is in a contact state with the predetermined body part, thereby giving the visual stimulation.

4. The sensation presenting system according to claim 1, wherein
the tactual sensation presenting means halts the tactual sensing unit with the tactual sensing unit contacting the predetermined body part in order to keep giving the tactual stimulation, and
the visual sensation presenting means presents a motional video picture in which the tactual-sensing-unit pseudo image displayed in the virtual space moves in a predetermined direction, thereby giving the visual stimulation.

5. The sensation presenting system according to claim 1, wherein
the tactual sensation presenting means moves the tactual sensing unit with the tactual sensing unit contacting the predetermined body part in order to give the tactual stimulation, and
the visual sensation presenting means presents a motional video picture in which the bodily pseudo image moves in the predetermined direction with the tactual-sensing-unit pseudo image displayed in the virtual space standing still, thereby giving the visual stimulation.

6. A sensation presenting device comprising:
control means that controls:
a tactual sensation presenting means that gives a tactual stimulation to a predetermined body part of a user by a tactual sensing unit; and
a visual sensation presenting means which displays a bodily pseudo image corresponding to the predetermined body part and a tactual-sensing-unit pseudo image corresponding to the tactual sensing unit in a virtual space, and which presents the user a motional video picture in which the tactual-sensing-unit pseudo image gives a virtual tactual stimulation to the bodily pseudo image, thereby giving a visual stimulation to the user,
wherein the control means causes the visual sensation presenting means to present a motional video picture different from an operation of giving the tactual stimulation to the predetermined body part by the tactual sensing unit, and allows the user to perceive a tactual stimulation corresponding to the virtual tactual stimulation based on the visual stimulation given by the motional video picture and the tactual stimulation given by the tactual sensing unit.

7. The sensation presenting device according to claim 6, wherein the control means transmits:
to the tactual sensation presenting means, an operation instruction of giving the tactual stimulation by moving the tactual sensing unit with the tactual sensing unit contacting the predetermined body part, and
to the visual sensation presenting means, video data of presenting, with the tactual-sensing-unit pseudo image being superimposed on the bodily pseudo image in the virtual space, a motional video picture in which the tactual-sensing-unit pseudo image moves by a travel distance different from an actual travel distance of the tactual sensing unit, thereby giving a visual stimulation to the user.

8. The sensation presenting device according to claim 6, wherein the control means transmits:
to the tactual sensation presenting means, an operation instruction of giving the tactual stimulation by causing the tactual sensing unit to contact/non-contact the predetermined body part, and
to the visual sensation presenting means, video data of presenting a motional video picture in which the tactual-sensing-unit pseudo image is superimposed on the bodily pseudo image in the virtual space when the tactual sensing unit is in a non-contact state with the predetermined body part, and the tactual-sensing-unit pseudo image is moved apart from the bodily pseudo image when the tactual sensing unit is in a contact state with the predetermined body part, thereby giving the visual stimulation.

9. The sensation presenting device according to claim 6, wherein the control means transmits:
to the tactual sensation presenting means, an operation instruction of halting the tactual sensing unit with the tactual sensing unit contacting the predetermined body part in order to keep giving the tactual stimulation, and
to the visual sensation presenting means, video data of presenting a motional video picture in which the tactual-sensing-unit pseudo image displayed in the virtual space moves in a predetermined direction, thereby giving the visual stimulation.

10. The sensation presenting device according to claim 6, wherein the control means transmits:
to the tactual sensation presenting means, an operation instruction of moving the tactual sensing unit with the tactual sensing unit contacting the predetermined body part in order to give the tactual stimulation, and
to the visual sensation presenting means, video data of presenting a motional video picture in which the bodily pseudo image is moved in the predetermined direction with the tactual-sensing-unit pseudo image displayed in the virtual space standing still, thereby giving the visual stimulation,

11. The sensation presenting system according to claim 1, wherein the tactual sensation presenting means and the visual sensation presenting means are provided on a casing.

12. The sensation presenting system according to claim 2, wherein the tactual sensation presenting means and the visual sensation presenting means are provided on a casing.

13. The sensation presenting system according to claim 3, wherein the tactual sensation presenting means and the visual sensation presenting means are provided on a casing.

14. The sensation presenting system according to claim 4, wherein the tactual sensation presenting means and the visual sensation presenting means are provided on a casing.

15. New The sensation presenting system according to claim 5, wherein the tactual sensation presenting means and the visual sensation presenting means are provided on a casing.
